(19) United States
(12) Patent Application Publication
(10) Pub. No.: US 2025/0201261 A1
(43) Pub. Date: Jun. 19, 2025

(54) Audio Signal Processing Method, Electronic Device and Non-Transitory Readable Storage Medium

(71) Applicant: VIVO MOBILE COMMUNICATION CO., LTD., Dongguan (CN)

(72) Inventor: Yuliang He, Dongguan (CN)

(21) Appl. No.: 19/069,599

(22) Filed: Mar. 4, 2025

Related U.S. Application Data
(63) Continuation of application No. PCT/CN2023/115441, filed on Aug. 29, 2023.

(30) Foreign Application Priority Data
Sep. 5, 2022 (CN) 202211095430.7

(51) Int. Cl. G10L 21/0232; G10L 21/0216; G10L 21/038

(52) U.S. Cl. CPC G10L 21/0232; G10L 21/038; G10L 2021/02165

(57) ABSTRACT

An audio signal processing method includes dividing a target frequency range into a first frequency band and a second frequency band based on a noise frequency band of a first audio signal and a noise frequency band of a second audio signal; performing first fusion processing on transmission channel information corresponding to the first audio signal and transmission channel information corresponding to the second audio signal in the first frequency band; performing second fusion processing on the transmission channel information corresponding to the first audio signal and the transmission channel information corresponding to the second audio signal in the second frequency band; and performing noise reduction on a target audio signal in which fusion processing is performed on corresponding transmission channel information. The target audio signal includes at least one of the first audio signal or the second audio signal.

### CROSS-REFERENCE TO RELATED APPLICATIONS

This application is a Bypass Continuation Application of International Patent Application No. PCT/CN2023/115441, filed Aug. 29, 2023, and claims priority to Chinese Patent Application No. 202211095430.7, filed Sep. 5, 2022, the disclosures of which are hereby incorporated by reference in their entireties.

### BACKGROUND OF THE INVENTION

### Field of the Invention

This application belongs to the field of audio technologies, and in particular, relates to an audio signal processing method, an electronic device, and a non-transitory readable storage medium.

### Description of Related Art

Currently, a plurality of microphones are generally disposed in an electronic device. A user may perform a call, recording, video recording, or the like through the plurality of microphones. However, in different audio processing scenarios, ambient wind noise greatly reduces a subjective listening sense of audio.

### SUMMARY OF THE INVENTION

According to a first aspect, an embodiment of this application provides an audio signal processing method. The method includes: dividing a target frequency range into a first frequency band and a second frequency band based on a noise frequency band of a first audio signal and a noise frequency band of a second audio signal, where the first audio signal is an audio signal obtained by collecting a target audio source by a first microphone, and the second audio signal is an audio signal obtained by collecting the target audio source by a second microphone; performing first fusion processing on transmission channel information corresponding to the first audio signal and transmission channel information corresponding to the second audio signal in the first frequency band; performing second fusion processing on the transmission channel information corresponding to the first audio signal and the transmission channel information corresponding to the second audio signal in the second frequency band; and performing noise reduction on a target audio signal in which fusion processing is performed on corresponding transmission channel information, where the target audio signal includes at least one of the first audio signal or the second audio signal.

According to a second aspect, an embodiment of this application provides an audio signal processing apparatus. The apparatus includes a division module, a fusion module, and a noise reduction module. The division module is configured to divide a target frequency range into a first frequency band and a second frequency band based on a noise frequency band of a first audio signal and a noise frequency band of a second audio signal, where the first audio signal is an audio signal obtained by collecting a target audio source by a first microphone, and the second audio signal is an audio signal obtained by collecting the target audio source by a second microphone. The fusion module is configured to perform first fusion processing on transmission channel information corresponding to the first audio signal and transmission channel information corresponding to the second audio signal in the first frequency band; The fusion module is further configured to perform second fusion processing on the transmission channel information corresponding to the first audio signal and the transmission channel information corresponding to the second audio signal in the second frequency band. The noise reduction module is configured to perform noise reduction on a target audio signal in which fusion processing is performed on corresponding transmission channel information, where the target audio signal includes at least one of the first audio signal or the second audio signal.

According to a third aspect, an embodiment of this application provides an electronic device. The electronic device includes a processor and a memory. The memory stores a program or instructions executable on the processor, and when the program or the instructions are executed by the processor, the steps of the method according to the first aspect are implemented.

According to a fourth aspect, an embodiment of this application provides a non-transitory readable storage medium. The non-transitory readable storage medium stores a program or instructions, and when the program or the instructions are executed by a processor, the steps of the method according to the first aspect are implemented.

According to a fifth aspect, an embodiment of this application provides a chip. The chip includes a processor and a communication interface, the communication interface is coupled to the processor, and the processor is configured to run a program or instructions to implement the method according to the first aspect.

According to a sixth aspect, an embodiment of this application provides a computer program product. The program product is stored in a non-transitory storage medium, and the program product is executed by at least one processor to implement the method according to the first aspect.

### BRIEF DESCRIPTION OF THE DRAWINGS

The terms Fig., Figs., Figure, and Figures are used interchangeably in the specification to refer to the corresponding figures in the drawings.

FIG. 1 is a flowchart of an audio signal processing method according to an embodiment of this application;

FIG. 2 is a schematic diagram 1 of an audio signal processing method according to an embodiment of this application;

FIG. 3 is a schematic diagram 2 of an audio signal processing method according to an embodiment of this application;

FIG. 4 is a schematic diagram 3 of an audio signal processing method according to an embodiment of this application;

FIG. 5 is a schematic diagram 4 of an audio signal processing method according to an embodiment of this application;

FIG. 6 is a schematic diagram 5 of an audio signal processing method according to an embodiment of this application;

FIG. 7 is a schematic diagram of an information flow in which an audio signal processing method is applied to dual-microphone stereo robust wind noise detection suppression according to an embodiment of this application;

FIG. 8 is a schematic diagram of an audio signal processing apparatus according to an embodiment of this application;

FIG. 9 is a schematic diagram of an electronic device according to an embodiment of this application; and

FIG. 10 is a schematic diagram of hardware of an electronic device according to an embodiment of this application.

### DESCRIPTION OF THE INVENTION

The technical solutions in the embodiments of this application are clearly described in the following with reference to the accompanying drawings in the embodiments of this application. Apparently, the described embodiments are some rather than all of the embodiments of this application. All other embodiments obtained by a person of ordinary skill in the art based on the embodiments of this application fall within the protection scope of this application.

The specification and claims of this application, and terms “first” and “second” are used to distinguish similar objects, but are not used to describe a specific sequence or order. It should be understood that the data termed in such a way are interchangeable in appropriate circumstances, so that the embodiments of this application can be implemented in orders other than the order illustrated or described herein. In addition, the objects distinguished by “first” and “second” are usually of a same type, without limiting a quantity of objects, for example, there may be one or more first objects. In addition, “and/or” in the description and the claims means at least one of the connected objects, and the character “/” in this specification generally indicates an “or” relationship between the associated objects.

An audio signal processing method and apparatus, an electronic device, and a non-transitory readable storage medium provided in the embodiments of this application are described in detail below with reference to the accompanying drawings by using embodiments and application scenarios thereof.

During an outdoor call or audio recording, an electronic device usually collects a large amount of ambient sound, including various stationary noise and non-stationary noise. Generally, noise comes from various sound sources in an environment. However, wind noise in an audio collection scenario is mainly caused by a turbulent airflow near a microphone membrane. Consequently, a microphone generates a relatively high signal level, and a sound source of the wind noise is near the microphone. Natural wind noise mainly occurs in a low frequency range of 1 kHz and is rapidly attenuated when tending to a high frequency. A burst of wind often causes wind noise lasting from dozens to hundreds of milliseconds. In addition, due to a sudden burst of wind, wind noise may generate a high amplitude value that exceeds an expected amplitude of collected audio, and exhibit a significant non-stationary characteristic, which greatly reduces a subjective listening sense of the audio. Therefore, an effective wind noise suppression method is required.

Currently, in terms of technical means, the wind noise suppression method includes an acoustic method and a signal processing method. The acoustic method is to isolate the wind noise from a physical perspective, and suppress interference of the wind noise from a source of signal collection. For example, wind noise suppression is implemented by using a windshield, an anti-wind noise conduit, and an accelerometer pick up. However, an application scenario of the method is limited by a physical condition. The signal processing method is to suppress or separate, through signal processing, the wind noise for audio mixed with the wind noise, and may also include reconstruction of damaged audio. Broadly speaking, the signal processing method can deal with various wind noise scenarios.

In the signal processing method, a conventional wind noise suppression policy is generally established based on a single microphone (or microphone). Wind noise detection, estimation, and suppression are implemented by using a single-microphone wind noise feature by using a spectral centroid method, a noise template method, a morphology method, or a deep learning method. However, a current electronic device such as a smartphone or a true wireless stereo headset is generally equipped with two or more microphones. Based on the foregoing wind noise formation principle, wind noise collected by two microphones is formed by turbulence near a relatively independent microphone. Generally, coherence (or correlation) between the two microphones is very low. Conventional dual-microphone wind noise suppression relies on this characteristic to a great extent, and wind noise is detected by using a frequency-domain magnitude-squared coherence (MSC) coefficient, and the detected wind noise is mapped to a wind noise suppression gain. However, in a dual-microphone stereo, a wind noise detection result generally includes all dual-microphone wind noise frequencies. Therefore, a detection and estimation result may correspond to only one microphone, and is not applicable to the other microphone.

It can be learned that the conventional dual-microphone wind noise suppression signal processing method usually relies heavily on the MSC feature, and then implements wind noise suppression in combination with a single-microphone wind noise feature with relatively low reliability. However, there are the following disadvantages.
1. The wind noise detection result based on the dual-microphone MSC includes all the dual-microphone wind noise frequencies and is not applicable to the two microphones, and directly mapping the detected wind noise to a wind noise gain damages audio on a low-wind-noise bandwidth microphone.
2. Reliability of the single-microphone feature is relatively poor, resulting in insufficient robustness of wind noise suppression.

Consequently, robustness of processing the audio signal by the electronic device is relatively poor.

To resolve the foregoing problems, in the audio signal processing method provided in the embodiments of this application, a target frequency range may be divided into a first frequency band and a second frequency band based on a noise frequency band of a first audio signal and a noise frequency band of a second audio signal. The first audio signal is an audio signal obtained by collecting a target audio source by a first microphone, and the second audio signal is an audio signal obtained by collecting the target audio source by a second microphone. First fusion processing is performed on transmission channel information corresponding to the first audio signal and transmission channel information corresponding to the second audio signal in the first frequency band. Second fusion processing is performed on the transmission channel information corresponding to the first audio signal and the transmission channel information corresponding to the second audio signal in the second frequency band. Noise reduction is performed on a target audio signal in which fusion processing is performed on corresponding transmission channel information. The target audio signal includes at least one of the first audio signal or the second audio signal. According to this solution, before performing noise reduction processing on audio signals collected by different microphones, an electronic device may first perform fusion processing on transmission channel information based on frequency bands obtained through division and transmission channel information corresponding to each audio signal, and then perform noise reduction on an audio signal in which fusion processing is performed on corresponding transmission channel information. Therefore, the electronic device may process an audio signal with reference to transmission channel information corresponding to different audio signals in different frequency bands obtained through division rather than a feature of a single audio signal or all frequencies of a plurality of audio signals, so that robustness of processing the audio signal by the electronic device can be improved.

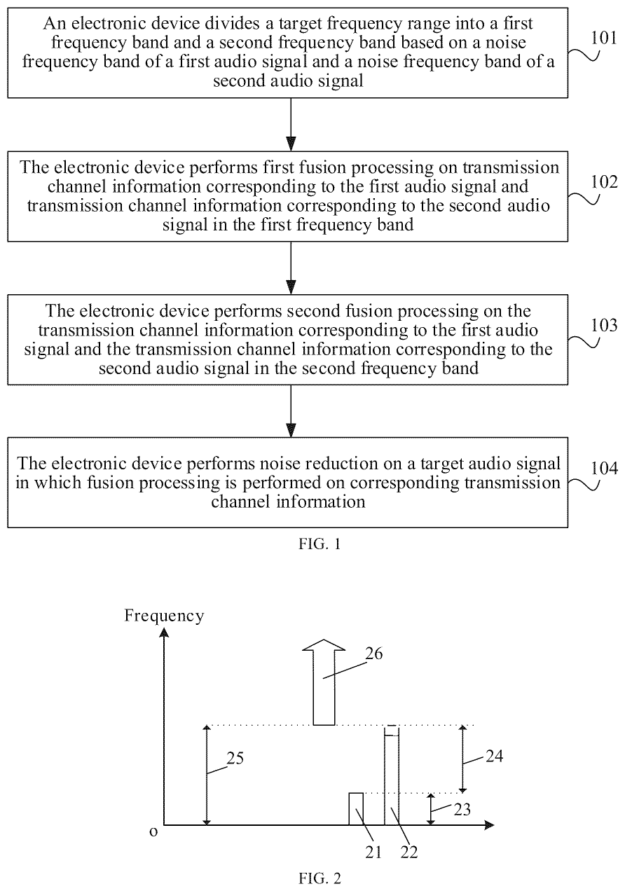

An embodiment of this application provides an audio signal processing method. FIG. 1 is a flowchart of an audio signal processing method according to an embodiment of this application. As shown in FIG. 1, the audio signal processing method provided in this embodiment of this application may include the following step 101 to step 104. The following describes the method by using an example in which an electronic device performs the method.

Step 101: The electronic device divides a target frequency range into a first frequency band and a second frequency band based on a noise frequency band of a first audio signal and a noise frequency band of a second audio signal.

In this embodiment of in this application, the first audio signal is an audio signal obtained by collecting a target audio source by a first microphone, and the second audio signal is an audio signal obtained by collecting the target audio source by a second microphone.

Optionally, in this embodiment of this application, the first audio signal and the second audio signal are simultaneously collected audio signals.

Optionally, in this embodiment of this application, the first microphone and the second microphone may be microphones disposed in a same electronic device, or may be microphones disposed in different electronic devices.

In this embodiment of this application, the target frequency range is a frequency range formed by a frequency of the first audio signal and a frequency of the second audio signal.

Optionally, in this embodiment of this application, the target frequency range may further include a wind noise-free frequency band other than the first frequency band and the second frequency band.

Optionally, in this embodiment of this application, the first frequency band may be an intersection of the noise frequency band of the first audio signal and the noise frequency band of the second audio signal.

Optionally, in this embodiment of this application, the second frequency band may be a difference set between the noise frequency band of the first audio signal and the noise frequency band of the second audio signal.

In this embodiment of this application, there is further at least one of the following that: the first frequency band may be the intersection of the frequency bands, or the second frequency band may be the difference set between the frequency bands, so that flexibility of dividing the target frequency range by the electronic device can be improved.

Optionally, in this embodiment of this application, the noise frequency band of the first audio signal and the noise frequency band of the second audio signal may be obtained based on a target coherence coefficient between the first audio signal and the second audio signal.

Optionally, in this embodiment of this application, the target coherence coefficient may include at least one of the following:
(a) a magnitude-squared coherence coefficient (namely, Magnitude-Squared Coherence);
(b) a relative deviation coefficient;
(c) a relative strength sensitivity coefficient;
(d) a magnitude-squared coherence coefficient of an amplitude spectrum; or
(e) a magnitude-squared coherence coefficient of a phase spectrum.

In this embodiment of this application, the target coherence coefficient is used for indicating a coherence feature between the first audio signal and the second audio signal and is generally generated based on a dissimilarity metric or a similarity metric with a value between 0 and 1. A process of determining the target coherence coefficient is as follows.

First, within the target frequency range, frequency coherence (namely, coherence) may be represented as the following formula (1):

$$COH ( ω ) = \frac{{P}_{X Y} ( ω )}{\sqrt{{P}_{X} ( ω ) {P}_{Y} ( ω )}} \qquad ( 1 )$$

Pₓ(ω) is a power spectrum density of a first audio signal X(ω), P_{Y}(ω) is a power spectrum density of a second audio signal Y(ω), and P_{XY}(ω) is a cross power spectrum density between the first audio signal and the second audio signal. COH(ω) is a complex number, and |COH(ω)|≤1. The equation is workable when and only when the first audio signal and the second audio signal are completely coherent. To avoid extraction of square root, the magnitude-squared coherence coefficient in (a) is usually used, and may be represented as the following formula (2).

$$MSC ( ω ) = {\vert COH ( ω ) \vert}^{2} = \frac{\vert {P}_{X Y} ( ω ) {\vert}^{2}}{{P}_{X} ( ω ) {P}_{Y} ( ω )} \qquad ( 2 )$$

Apparently, a normalization effect of MSC(ω) is not sensitive to relative strengths of X(ω) and Y(ω), but the relative strengths of the first audio signal and the second audio signal have significance in determining noise. In view of this, a normalized power level difference is defined again, that is, the relative deviation coefficient in (b) may be represented as the following formula (3).

$$NPLD ( ω ) = \frac{\vert {P}_{X} ( ω ) - {P}_{Y} ( ω ) \vert}{\vert {P}_{X} ( ω ) + {P}_{Y} ( ω ) \vert} \qquad ( 3 )$$

Apparently, 0≤NPLD(ω)≤1 is an expected dissimilarity metric between audio signals. In addition, COH may alternatively be transformed into a form sensitive to the relative strengths of the first audio signal and the second audio signal, that is, the relative strength sensitivity coefficient in (c), which is shown in the following formula (4).

$$COH\_AS ( ω ) = \frac{2 \vert {P}_{X Y} ( ω ) \vert}{{P}_{X} ( ω ) + {P}_{Y} ( ω )} \qquad ( 4 )$$

The formula (2) may alternatively be transformed into a version in which only an amplitude spectrum or a phase spectrum is considered. A form in which only the amplitude spectrum is considered is the magnitude-squared coherence coefficient of the amplitude spectrum in (d) and may be represented as the following formula (5).

$$MSC\_AMP ( ω ) = \frac{{{P}_{\vert X \vert \vert Y \vert} ( ω )}^{2}}{{P}_{\vert X \vert} ( ω ) {P}_{\vert Y \vert} ( ω )} \qquad ( 5 )$$

Apparently, the following successive inequalities (6) may be obtained, which measure an expected similarity between the audio signals.

$$0 \leq COH\_AS {( ω )}^{2} \leq MSC ( ω ) \leq MSC\_AMP ( ω ) \leq 1 \qquad ( 6 )$$

In conclusion, any other similarity or dissimilarity criterion with a value between 0 and 1 is available. In this way, the target coherence coefficient between the first audio signal and the second audio signal may be determined.

In this embodiment of this application, because the target coherence coefficient may include at least one of (a) to (e), the electronic device may obtain different noise frequency bands of the audio signals based on different target coherence coefficients between the first audio signal and the second audio signal, so that when the electronic device divides the target frequency range based on the noise frequency band, flexibility of dividing the target frequency range is improved.

Optionally, in this embodiment of this application, after determining the target coherence coefficient, the electronic device may obtain an expected presence probability P_{H}_{₁}(ω) of the audio signal based on a linear or non-linear combination of the target coherence coefficient. P_{H}_{₁}(ω) may be represented as the following formula (7).

$${P}_{{H}_{1}} ( ω ) = f ( COH\_AS ( ω ) , MSC ( ω ) , MSC\_AMP ( ω ) , NPLD ( ω ) ) \qquad ( 7 )$$

It may be understood that because noise energy is at a low frequency band and is rapidly attenuated when tending to a high frequency band, the electronic device may find and estimate a union frequency band between the noise frequency band of the first audio signal and the noise frequency band of the second audio signal from a low frequency to a high frequency based on P_{H}_{₁}(ω).

Optionally, in this embodiment of this application, after estimating the union frequency band, the electronic device may first correct P_{X}(ω) and P_{Y}(ω) based on a harmonic location of a pitch, to avoid bandwidth over-estimation. Then, the electronic device may estimate the noise frequency band of the first audio signal and the noise frequency band of the second audio signal from the union frequency band based on the corrected P_{X}(ω) and P_{Y}(ω).

In this embodiment of this application, because the noise frequency band of the first audio signal and the noise frequency band of the second audio signal may be obtained based on the target coherence coefficient between the first audio signal and the second audio signal, accuracy of obtaining the noise frequency band of the audio signal can be improved.

The following describes in detail a method for the electronic device to divide the target frequency range into the first frequency band, the second frequency band, and the wind noise-free frequency band.

Optionally, in this embodiment of this application, after estimating the noise frequency band (which is referred to as a noise frequency band A below) of the first audio signal and the noise frequency band (which is referred to as a noise frequency band B below) of the second audio signal based on the target coherence coefficient, the electronic device may divide the target frequency range into:
a. An intersection (namely, the first frequency band) of the noise frequency band A and the noise frequency band B;
b. A difference set (namely, the second frequency band) between an extension wind noise frequency band corresponding to the noise frequency band A and the noise frequency band B and the intersection; and
c. The wind noise-free frequency band.

The following exemplarily describes the audio signal processing method provided in this embodiment of this application with reference to the accompanying drawings.

For example, as shown in FIG. 2, the electronic device may first estimate a noise frequency band 25 (namely, the extension wind noise frequency band) based on a noise frequency band 21 (namely, the noise frequency band of the first audio signal) and a noise frequency band 22 (namely, the noise frequency band of the second audio signal), and then may divide a target frequency range into a frequency band 23 (namely, the first frequency band), a frequency band 24 (namely, the second frequency band), and a frequency band 26 (namely, the wind noise-free frequency band). It can be learned that the frequency band 23 is an intersection of the noise frequency band 21 and the noise frequency band 22, and the frequency band 24 is a difference set between the noise frequency band 25 corresponding to the noise frequency band 21 and the noise frequency band 22 and the frequency band 23.

Optionally, in this embodiment of this application, when estimating the noise frequency band of the first audio signal and the noise frequency band of the second audio signal, the electronic device may generate, based on the magnitude-squared coherence coefficient in (a) and the relative deviation coefficient in (b), an initial gain corresponding to the first audio signal and an initial gain corresponding to the second audio signal, so as to perform noise reduction on the audio signal.

Step 102: The electronic device performs first fusion processing on transmission channel information corresponding to the first audio signal and transmission channel information corresponding to the second audio signal in the first frequency band.

In this embodiment of this application, the first audio signal and the second audio signal each correspond to a transmission channel.

Optionally, in this embodiment of this application, the transmission channel information may include information such as an amplitude spectrum, a wind noise gain, and a noise stabilization gain of an audio signal in a corresponding transmission channel.

Optionally, in this embodiment of this application, step 102 may be implemented through the following step 102a or step 102b.

Step 102a: When a noise strength of a first sub-audio signal is less than a noise strength of a second sub-audio signal, the electronic device combines transmission channel information corresponding to the first sub-audio signal and transmission channel information corresponding to the second sub-audio signal by using a first weight.

Step 102b: When a noise strength of a first sub-audio signal is greater than a noise strength of a second sub-audio signal, the electronic device combines transmission channel information corresponding to the second sub-audio signal and transmission channel information corresponding to the first sub-audio signal by using a second weight.

In this embodiment of this application, the first sub-audio signal is an audio signal of the first audio signal in the first frequency band. The second sub-audio signal is an audio signal of the second audio signal in the first frequency band.

It may be understood that the transmission channel information corresponding to the first sub-audio signal is transmission channel information of a transmission channel corresponding to the first audio signal in the first frequency band. The transmission channel information of the second sub-audio signal is transmission channel information of a transmission channel corresponding to the second audio signal in the first frequency band.

Optionally, in this embodiment of this application, the first weight and the second weight may be the same or may be different.

In this embodiment of this application, after combining one piece of transmission channel information and the other piece of transmission channel information, the electronic device still reserves the one piece of transmission channel information.

In this embodiment of this application, the electronic device may fuse the transmission channel information in the first frequency band in different manners based on a size relationship between the noise strength of the first sub-audio signal and the noise strength of the second sub-audio signal, so that flexibility of fusing the transmission channel information by the electronic device can be improved.

Step 103: The electronic device performs second fusion processing on the transmission channel information corresponding to the first audio signal and the transmission channel information corresponding to the second audio signal in the second frequency band.

Optionally, in this embodiment of this application, step 103 may be implemented through the following step 103a or step 103b.

Step 103a: When a third sub-audio signal is a noise-free audio signal, the electronic device combines transmission channel information corresponding to the third sub-audio signal and transmission channel information corresponding to a fourth sub-audio signal by using a third weight.

Step 103b: When a fourth sub-audio signal is a noise-free audio signal, the electronic device combines transmission channel information corresponding to the fourth sub-audio signal and transmission channel information corresponding to a third sub-audio signal by using a fourth weight.

In this embodiment of this application, the third sub-audio signal is an audio signal of the first audio signal in the second frequency band. The fourth sub-audio signal is an audio signal of the second audio signal in the second frequency band.

It may be understood that the transmission channel information corresponding to the third sub-audio signal is transmission channel information of the transmission channel corresponding to the first audio signal in the second frequency band. The transmission channel information of the fourth sub-audio signal is transmission channel information of the transmission channel corresponding to the second audio signal in the second frequency band.

Optionally, in this embodiment of this application, the third weight and the fourth weight may be the same or may be different.

In this embodiment of this application, when the third sub-audio signal is the noise-free audio signal, or when the fourth sub-audio signal is the noise-free audio signal, the electronic device may fuse the transmission channel information in the second frequency band in different manners, so that the flexibility of fusing the transmission channel information by the electronic device can be improved.

Optionally, in this embodiment of this application, a processing strength of the first fusion processing may be less than a processing strength of the second fusion processing. In other words, both the first weight and the second weight may be less than a target weight, and the target weight is a smallest weight between the third weight and the fourth weight.

For example, both the first weight and the second weight may be 0.5. In this case, the electronic device may complete combination of the transmission channel information in the first frequency band by using the weight of 0.5. Both the third weight and the fourth weight may be 1. In this case, the electronic device may complete combination of the transmission channel information in the second frequency band by using the weight of 1, that is, directly replace one piece of transmission channel information with the other piece of transmission channel information in the second frequency band.

It can be learned that the first fusion processing may implement fusion of the transmission channel information, and the second fusion processing may implement replacement of the transmission channel information.

In this embodiment of this application, because the processing strength of the first fusion processing may be less than the processing strength of the second fusion processing, fusion processing may be performed on the transmission channel information in different frequency bands by using different processing strengths, so that the flexibility of fusing the transmission channel information by the electronic device can be improved.

Step 104: The electronic device performs noise reduction on a target audio signal in which fusion processing is performed on corresponding transmission channel information.

In this embodiment of this application, the target audio signal includes at least one of the first audio signal or the second audio signal.

It may be understood that the electronic device may perform noise reduction on an audio signal in which fusion processing is performed on corresponding transmission channel information in the first audio signal and the second audio signal.

Optionally, in this embodiment of this application, the transmission channel information on which fusion processing has been performed may include a first gain and a second gain.

In this embodiment of this application, the first gain is used for performing noise reduction on the first audio signal, and the second gain is used for performing noise reduction on the second audio signal.

Optionally, in this embodiment of this application, at least one of the first gain or the second gain is a gain obtained by performing fusion processing on an initial gain in the transmission channel information.

Optionally, in this embodiment of this application, if the target audio signal includes the first audio signal and the second audio signal, the electronic device may apply the first gain to an amplitude spectrum of the first audio signal, and apply the second gain to an amplitude spectrum of the second audio signal, to perform noise reduction on the first audio signal and the second audio signal.

Optionally, in this embodiment of this application, step 104 may be implemented through the following step 104a.

Step 104a: When a signal to wind noise ratio of the target audio signal is less than or equal to a preset threshold, the electronic device performs noise reduction on the target audio signal by using a target noise reduction method.

In this embodiment of this application, the target noise reduction method is a noise reduction method of performing first noise reduction processing on the target audio signal in a third frequency band and performing second noise reduction processing on the target audio signal in a fourth frequency band.

In this embodiment of this application, a frequency of the third frequency band is less than or equal to a first frequency threshold, and a frequency of the fourth frequency band is greater than or equal to a second frequency threshold.

Optionally, in this embodiment of this application, both the first frequency threshold and the second frequency threshold may be default values of the electronic device, or may be set by a user based on an actual use requirement.

In this embodiment of this application, a processing strength of the first noise reduction processing is less than a processing strength of the second noise reduction processing.

Optionally, in this embodiment of this application, the processing strength of the first noise reduction processing may be close to 0.

Optionally, in this embodiment of this application, the electronic device may determine a signal to wind noise ratio of an audio signal based on a noise frequency band of the audio signal.

Optionally, in this embodiment of this application, the preset threshold may be a default value of the electronic device, or may be set by a user based on an actual use requirement.

It may be understood that the signal to wind noise ratio of the audio signal is less than or equal to the preset threshold, that is, there is a noise signal with an ultra-large frequency band in the audio signal. If noise reduction is performed on the audio signal, conservative noise reduction needs to tend to be performed on the audio signal. In other words, suppression on a low frequency band noise signal is reduced, and suppression is performed only on a part of high frequency band noise signal, that is, noise reduction is performed by using the target noise reduction method, to achieve a noise reduction effect in which a listening sense is more natural.

In this embodiment of this application, when the signal to wind noise ratio of the target audio signal is less than or equal to the preset threshold, the electronic device may perform noise reduction on the target audio signal by using the target noise reduction method (namely, performing the first noise reduction processing in the low frequency band, and performing the second noise reduction processing with a larger processing strength in the high frequency band). Therefore, it can be ensured that a listening sense of a target audio signal on which noise reduction has been performed is more natural.

In the audio signal processing method provided in this embodiment of this application, before performing noise reduction processing on audio signals collected by different microphones, an electronic device may first perform fusion processing on transmission channel information based on frequency bands obtained through division and transmission channel information corresponding to each audio signal, and then perform noise reduction on an audio signal in which fusion processing is performed on corresponding transmission channel information. Therefore, the electronic device may process an audio signal with reference to transmission channel information corresponding to different audio signals in different frequency bands obtained through division rather than a feature of a single audio signal or all frequencies of a plurality of audio signals, so that robustness of processing the audio signal by the electronic device can be improved.

Optionally, in this embodiment of this application, after step 104, the audio signal processing method provided in this embodiment of this application may further include the following step 105.

Step 105: The electronic device inserts a noise compensation audio signal into at least one target frequency band.

In this embodiment of this application, each target frequency band is a frequency band in which an audio signal on which noise reduction is performed is located within the target frequency range.

In this embodiment of this application, the noise compensation audio signal is used for compensating for an audio signal in a corresponding target frequency band.

Optionally, in this embodiment of this application, each target frequency band may one to one correspond to a noise compensation audio signal.

Optionally, in this embodiment of this application, the noise compensation audio signal may be an audio signal that has good continuity with an audio signal in a first target frequency band. The first target frequency band is a frequency band that is adjacent to the corresponding target frequency band and that does not include an audio signal on which noise reduction is performed.

In this embodiment of this application, because the electronic device may insert the noise compensation audio signal into the at least one target frequency band, continuity of the target audio signal on which noise reduction has been performed can be improved, thereby improving a subjective listening sense of the target audio signal.

The following exemplarily describes, with reference to the accompanying drawings, an example in which the audio signal processing method provided in this embodiment of this application is applied.

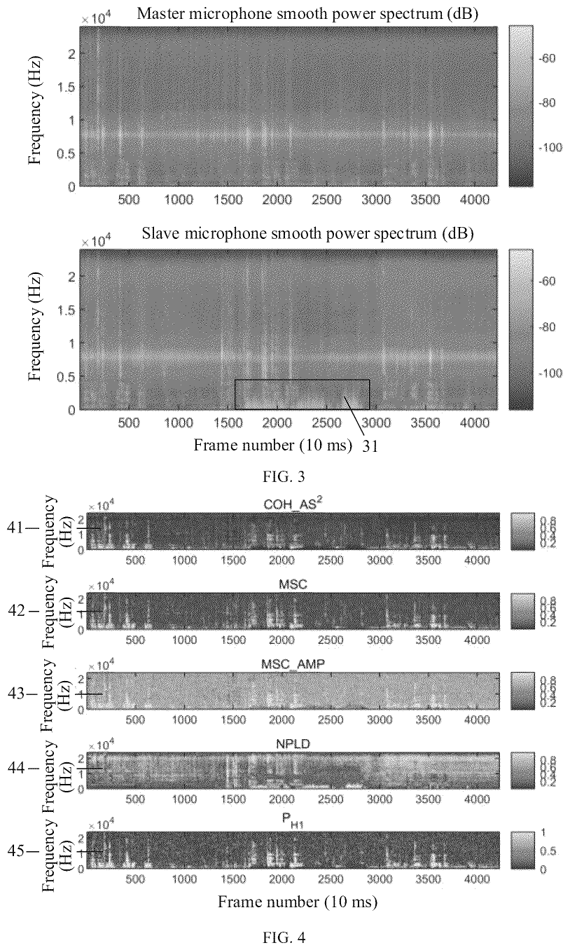

For example, an operating frequency band of an audio signal is usually within 24 kHz. FIG. 3 shows an input spectrogram of an example audio signal. As shown in FIG. 3, an audio signal (which is referred to as an audio signal A below) collected by a primary microphone and an audio signal (which is referred to as an audio signal B below) collected by a secondary microphone have significantly different wind noise frequency bands, and an interval 31 in a smooth power spectrum corresponding to the audio signal B is an interval that is severely contaminated with noise. To perform noise reduction on the collected audio signals, the electronic device may determine a target coherence coefficient between the two audio signals based on the audio signal A and the audio signal B.

FIG. 4 shows a target coherence coefficient determined by an electronic device and a comprehensive effect of the target coherence coefficient. As shown in FIG. 4, the target coherence coefficient determined by the electronic device includes: COH_AS² MSC MSC_AMP, and NPLD (namely, (a) to (d) in the foregoing embodiment). It can be learned from a smooth power spectrum 41 corresponding to COH_AS², a smooth power spectrum 42 corresponding to MSC a smooth power spectrum 43 corresponding to MSC_AMP and a smooth power spectrum 44 corresponding to NPLD that the target coherence coefficient exhibits different similarity determining tendencies as indicated by the inequality (6). Then, the electronic device may generate an expected presence probability P_{H}_{₁} of audio with higher robustness by combining the four features in different frequency bands by using different tendencies. A smooth power spectrum corresponding to P_{H}_{₁} is a smooth power spectrum 45 shown in FIG. 4. For example, the electronic device may find and estimate a noise frequency band in each audio signal based on the probability P_{H}_{₁}.

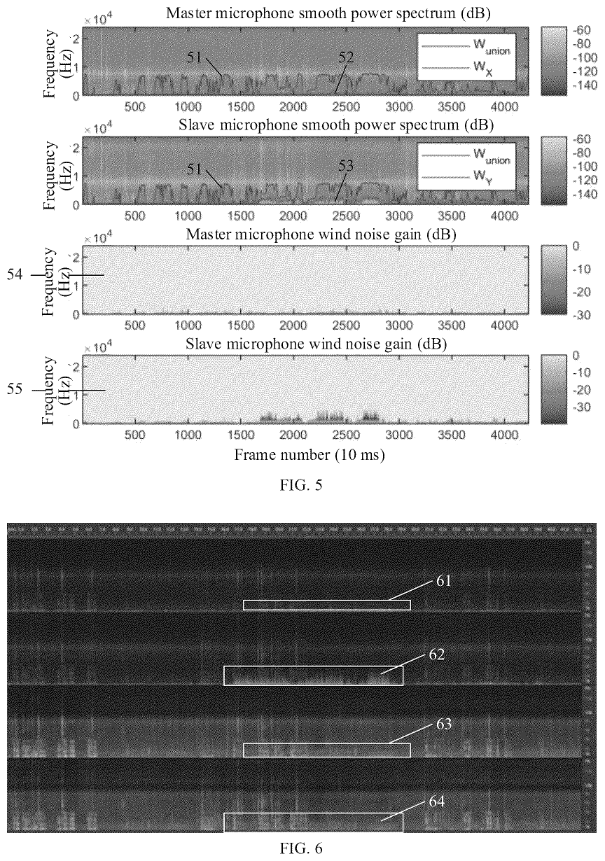

FIG. 5 shows a noise frequency band found and estimated by an electronic device and a corresponding wind noise gain. As shown in FIG. 5, a noise frequency band of the audio signal A is a frequency band corresponding to a curve 52, and a noise frequency band of the audio signal B is a frequency band corresponding to a curve 53. A frequency band corresponding to a curve 51 is an estimated union frequency band of the noise frequency band of the audio signal A and the noise frequency band of the audio signal B. Apparently, the union frequency band is over-estimated. It can be learned that each noise frequency band closely defines a frequency band in which noise exists. A smooth power spectrum 54 is a smooth power spectrum of a wind noise gain corresponding to the noise frequency band of the audio signal A, and a smooth power spectrum 55 is a smooth power spectrum of a wind noise gain corresponding to the noise frequency band of the audio signal B.

FIG. 6 shows a spectrogram before and after an electronic device performs noise reduction on an audio signal A and an audio signal B. As shown in FIG. 6, a wind noise frequency band 61 of the audio signal A is a frequency band 63 on which noise reduction processing has been performed, and a wind noise frequency band 62 of the audio signal B is a frequency band 64 on which noise reduction processing has been performed. It can be learned that strong noise in a stereo input is sufficiently effectively suppressed in a stereo output, and benefiting from fusion of transmission channel information, an audio signal with a low signal to wind noise ratio is effectively protected, so that a listening sense and sound quality of the audio signal are continuous and natural. In this way, noise reduction can be stably performed on the audio signal, to improve a noise reduction effect of the electronic device.

The following exemplarily describes an information flow of the audio signal processing method provided in this embodiment of this application with reference to the accompanying drawings.

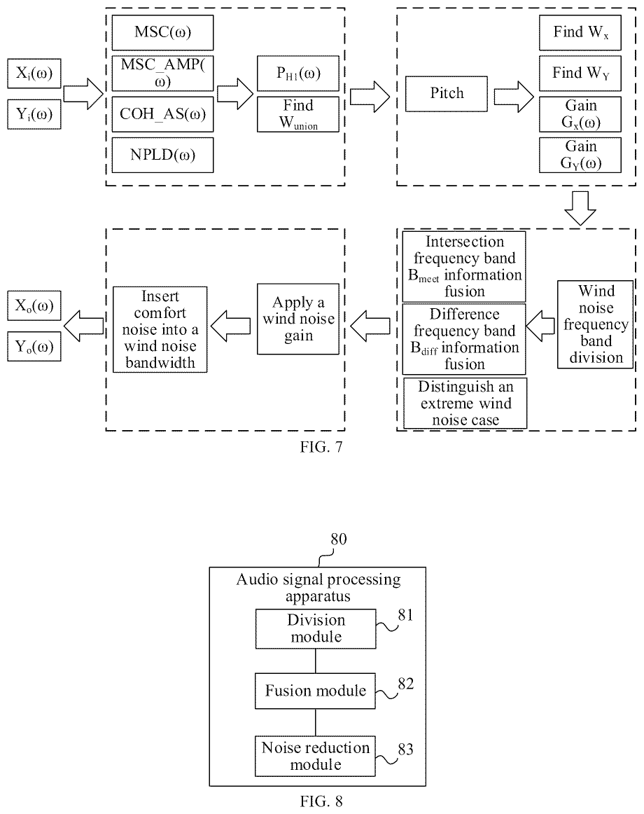

For example, FIG. 7 is a schematic diagram of an information flow in which an audio signal processing method is applied to dual-microphone stereo robust wind noise detection suppression according to an embodiment of this application. As shown in FIG. 7, after collecting an audio signal Xᵢ(ω) (namely, a first audio signal) and an audio signal Yᵢ(ω) namely, a second audio signal) through different microphones, an electronic device may obtain an expected presence probability P_{H}_{ᵢ}(ω) of the audio signal based on a target coherence coefficient between the two audio signals, and may find and estimate a dual-microphone union wind noise bandwidth Wᵤₙᵢₒₙ from a low frequency to a high frequency based on P_{H}_{₁}(ω).

Then, the electronic device may correct a single-microphone power spectrum based on a harmonic location of a pitch, to avoid bandwidth over-estimation, and find and estimate a single-microphone wind noise bandwidth W_{X}(namely, a noise frequency band of the first audio signal) and W_{Y} (namely, a noise frequency band of the second audio signal) in Wᵤₙᵢₒₙ based on the corrected single-microphone power spectrum.

Therefore, the electronic device may divide frequency domain (namely, a target frequency range) into a wind noise bandwidth intersection Bₘₑₑₜ (namely, a first frequency band), an extension wind noise bandwidth difference set B_{diff} (namely, a second frequency band), and a wind noise-free frequency band B_{clean} based on W_{X} and W_{Y}. For Bₘₑₑₜ, both microphones have wind noise. However, a wind noise strength of one transmission channel (or microphone) is usually less than a wind noise strength of the other transmission channel. Based on the single-microphone wind noise strength, fusion processing (namely, first fusion processing) may be performed on transmission channel information in a sub-band before wind noise suppression. In other words, weak-wind-noise transmission channel information (including an amplitude spectrum, a wind noise gain, a noise stabilization gain, and the like) is combined with a strong-wind-noise transmission channel information in an arithmetic or geometric average manner (that is, a first weight or a second weight). For B_{diff}, generally, one transmission channel is contaminated by wind noise, and the other transmission channel is not contaminated by wind noise. Similarly, before wind noise suppression, fusion processing (that is, second fusion processing) is performed on transmission channel information in the sub-band. In other words, wind noise-free transmission channel information is combined with transmission channel information with wind noise in a larger proportion (that is, a third weight or a fourth weight) in the sub-band. For B_{clean}, wind noise suppression is not performed. In addition, the electronic device may further distinguish an extreme wind noise case based on a single-microphone wind noise bandwidth. In an ultra-large bandwidth or a violent wind case that occasionally occurs, a signal to wind noise ratio of original audio is extremely low, and reliability of extreme wind noise suppression is poor. In this case, wind noise suppression tends to be conservative, suppression on low-frequency wind noise is reduced, and suppression is performed only on a part of high-frequency wind noise, so as to achieve a noise reduction effect in which a listening sense is more natural.

After the electronic device performs transmission channel information fusion, the electronic device may apply a wind noise gain (namely, the first gain and the second gain) to an amplitude spectrum of a transmission channel to complete wind noise suppression. However, continuity of an amplitude spectrum of audio obtained through wind noise suppression deteriorates, which depends on a recorded audio component, and the audio is interrupted or fluctuated in a listening sense. Therefore, the electronic device may insert comfort noise (that is, the noise compensation audio signal) into a frequency band (that is, the at least one target frequency band) obtained through wind noise suppression, so as to compensate an amount of comfort noise that has better continuity with an adjacent wind noise-free audio background, so that a subjective listening sense can be significantly improved. In this way, wind noise suppression can be completed, and noise reduced audio signals Xₒ(ω) and Yₒ(ω) are obtained.

An audio signal processing apparatus may perform the audio signal processing method provided in this embodiment of this application. In this embodiment of this application, an example in which the audio signal processing apparatus performs the audio signal processing method is used to describe the audio signal processing apparatus provided in this embodiment of this application.

With reference to FIG. 8, an embodiment of this application provides an audio signal processing apparatus 80. The audio signal processing apparatus 80 may include a division module 81, a fusion module 82, and a noise reduction module 83. The division module 81 may be configured to divide a target frequency range into a first frequency band and a second frequency band based on a noise frequency band of a first audio signal and a noise frequency band of a second audio signal, where the first audio signal is an audio signal obtained by collecting a target audio source by a first microphone, and the second audio signal is an audio signal obtained by collecting the target audio source by a second microphone. The fusion module 82 may be configured to perform first fusion processing on transmission channel information corresponding to the first audio signal and transmission channel information corresponding to the second audio signal in the first frequency band. The fusion module 82 may be further configured to perform second fusion processing on the transmission channel information corresponding to the first audio signal and the transmission channel information corresponding to the second audio signal in the second frequency band. The noise reduction module 83 may be configured to perform noise reduction on a target audio signal in which fusion processing is performed on corresponding transmission channel information, where the target audio signal includes at least one of the first audio signal or the second audio signal.

In a possible implementation, there may be further at least one of the following: The first frequency band may be an intersection of the noise frequency band of the first audio signal and the noise frequency band of the second audio signal. The second frequency band may be a difference set between the noise frequency band of the first audio signal and the noise frequency band of the second audio signal.

In a possible implementation, the fusion module 82 may be configured to: when a noise strength of a first sub-audio signal is less than a noise strength of a second sub-audio signal, combine transmission channel information corresponding to the first sub-audio signal and transmission channel information corresponding to the second sub-audio signal by using a first weight; or when a noise strength of a first sub-audio signal is greater than a noise strength of a second sub-audio signal, combine transmission channel information corresponding to the second sub-audio signal and transmission channel information corresponding to the first sub-audio signal by using a second weight. The first sub-audio signal is an audio signal of the first audio signal in the first frequency band. The second sub-audio signal is an audio signal of the second audio signal in the first frequency band.

In a possible implementation, the fusion module 82 may be configured to: when a third sub-audio signal is a noise-free audio signal, combine transmission channel information corresponding to the third sub-audio signal and transmission channel information corresponding to a fourth sub-audio signal by using a third weight; or when a fourth sub-audio signal is a noise-free audio signal, combine transmission channel information corresponding to the fourth sub-audio signal and transmission channel information corresponding to a third sub-audio signal by using a fourth weight. The third sub-audio signal is an audio signal of the first audio signal in the second frequency band. The fourth sub-audio signal is an audio signal of the second audio signal in the second frequency band.

In a possible implementation, a processing strength of the first fusion processing is less than a processing strength of the second fusion processing.

In a possible implementation, the noise reduction module 83 may be configured to: when a signal to wind noise ratio of the target audio signal is less than or equal to a preset threshold, perform noise reduction on the target audio signal by using a target noise reduction method. The target noise reduction method is a noise reduction method of performing first noise reduction processing on the target audio signal in a third frequency band and performing second noise reduction processing on the target audio signal in a fourth frequency band. A frequency of the third frequency band is less than or equal to a first frequency threshold, a frequency of the fourth frequency band is greater than or equal to a second frequency threshold, and a processing strength of the first noise reduction processing is less than a processing strength of the second noise reduction processing.

In a possible implementation, the audio signal processing apparatus 80 may further include an insertion module. The insertion module may be configured to insert a noise compensation audio signal into at least one target frequency band after the noise reduction module 83 performs noise reduction on the target audio signal in which fusion processing is performed on the corresponding transmission channel information. Each target frequency band is a frequency band in which an audio signal on which noise reduction is performed is located within the target frequency range. The noise compensation audio signal is used for compensating for an audio signal in a corresponding target frequency band.

In a possible implementation, the noise frequency band of the first audio signal and the noise frequency band of the second audio signal are obtained based on a target coherence coefficient between the first audio signal and the second audio signal.

In a possible implementation, the target coherence coefficient may include at least one of the following: a relative deviation coefficient; a relative strength sensitivity coefficient; a magnitude-squared coherence coefficient of an amplitude spectrum; or a magnitude-squared coherence coefficient of a phase spectrum.

In the audio signal processing apparatus provided in this embodiment of this application, before performing noise reduction processing on audio signals collected by different microphones, the audio signal processing apparatus may first perform fusion processing on transmission channel information based on divided frequency bands and transmission channel information corresponding to each audio signal, and then perform noise reduction on an audio signal in which fusion processing is performed on corresponding transmission channel information. Therefore, the audio signal processing apparatus may process an audio signal with reference to transmission channel information corresponding to different audio signals in different divided frequency bands rather than a feature of a single audio signal or all frequencies of a plurality of audio signals, so that robustness of processing the audio signal can be improved.

The audio signal processing apparatus in this embodiment of this application may be an electronic device, or may be a component in the electronic device, for example, an integrated circuit or a chip. The electronic device may be a terminal or a device other than the terminal. For example, the electronic device may be a mobile phone, a tablet computer, a notebook computer, a palm computer, a vehicle-mounted electronic device, a mobile internet device (MID), an augmented reality (AR)/virtual reality (VR) device, a robot, a wearable device, an ultra-mobile personal computer (UMPC), a netbook, or a personal digital assistant (PDA), or the electronic device may be a server, a network attached storage (NAS), a personal computer (PC), a television (TV), a teller machine, or an automated machine, which are not limited in the embodiments of this application.

The audio signal processing apparatus in this embodiment of this application may be an apparatus with an operating system. The operating system may be an Android operating system, an ios operating system, or another possible operating system. This is not limited in this embodiment of this application.

The audio signal processing apparatus provided in this embodiment of this application can implement the processes implemented in the method embodiments of FIG. 1 to FIG. 7. To avoid repetition, details are not described herein again.

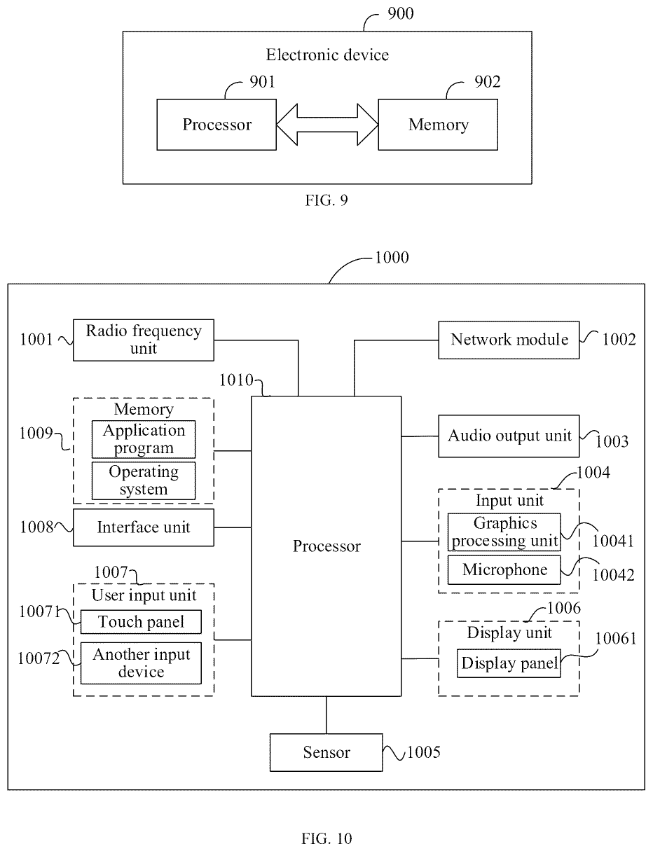

As shown in FIG. 9, an embodiment of this application further provides an electronic device 900. The electronic device 900 includes a processor 901 and a memory 902. The memory 902 stores a program or instructions executable on the processor 901. When the program or the instructions are executed by the processor 901, the processes of the foregoing embodiments of the audio signal processing method are implemented, and the same technical effects can be achieved. To avoid repetition, details are not described herein again.

It should be noted that, the electronic device in this embodiment of this application includes the mobile electronic device and the non-mobile electronic device.

FIG. 10 is a schematic diagram of a hardware structure of an electronic device for implementing an embodiment of this application.

The electronic device 1000 includes, but is not limited to, components such as a radio frequency unit 1001, a network module 1002, an audio output unit 1003, an input unit 1004, a sensor 1005, a display unit 1006, a user input unit 1007, an interface unit 1008, a memory 1009, and a processor 1010.

A person skilled in the art may understand that the electronic device 1000 may further include a power supply (such as a battery) for supplying power to the components. The power supply may logically connect to the processor 1010 through a power supply management system, thereby implementing functions, such as charging, discharging, and power consumption management, by using the power supply management system. The structure of the electronic device shown in FIG. 10 constitutes no limitation on the electronic device, and the electronic device may include more or fewer components than those shown in the figure, or some components may be combined, or a different component deployment may be used. Details are not described herein again.

The processor 1010 may be configured to divide a target frequency range into a first frequency band and a second frequency band based on a noise frequency band of a first audio signal and a noise frequency band of a second audio signal, where the first audio signal is an audio signal obtained by collecting a target audio source by a first microphone, and the second audio signal is an audio signal obtained by collecting the target audio source by a second microphone; perform first fusion processing on transmission channel information corresponding to the first audio signal and transmission channel information corresponding to the second audio signal in the first frequency band; perform second fusion processing on the transmission channel information corresponding to the first audio signal and the transmission channel information corresponding to the second audio signal in the second frequency band; and perform noise reduction on a target audio signal in which fusion processing is performed on corresponding transmission channel information, where the target audio signal includes at least one of the first audio signal or the second audio signal.

In a possible implementation, there may be further at least one of the following: The first frequency band may be an intersection of the noise frequency band of the first audio signal and the noise frequency band of the second audio signal. The second frequency band may be a difference set between the noise frequency band of the first audio signal and the noise frequency band of the second audio signal.

In a possible implementation, the processor 1010 may be configured to: when a noise strength of a first sub-audio signal is less than a noise strength of a second sub-audio signal, combine transmission channel information corresponding to the first sub-audio signal and transmission channel information corresponding to the second sub-audio signal by using a first weight; or when a noise strength of a first sub-audio signal is greater than a noise strength of a second sub-audio signal, combine transmission channel information corresponding to the second sub-audio signal and transmission channel information corresponding to the first sub-audio signal by using a second weight. The first sub-audio signal is an audio signal of the first audio signal in the first frequency band. The second sub-audio signal is an audio signal of the second audio signal in the first frequency band.

In a possible implementation, the processor 1010 may be configured to: when a third sub-audio signal is a noise-free audio signal, combine transmission channel information corresponding to the third sub-audio signal and transmission channel information corresponding to a fourth sub-audio signal by using a third weight; or when a fourth sub-audio signal is a noise-free audio signal, combine transmission channel information corresponding to the fourth sub-audio signal and transmission channel information corresponding to a third sub-audio signal by using a fourth weight. The third sub-audio signal is an audio signal of the first audio signal in the second frequency band. The fourth sub-audio signal is an audio signal of the second audio signal in the second frequency band.

In a possible implementation, a processing strength of the first fusion processing is less than a processing strength of the second fusion processing.

In a possible implementation, the processor 1010 may be configured to: when a signal to wind noise ratio of the target audio signal is less than or equal to a preset threshold, perform noise reduction on the target audio signal by using a target noise reduction method. The target noise reduction method is a noise reduction method of performing first noise reduction processing on the target audio signal in a third frequency band and performing second noise reduction processing on the target audio signal in a fourth frequency band. A frequency of the third frequency band is less than or equal to a first frequency threshold, a frequency of the fourth frequency band is greater than or equal to a second frequency threshold, and a processing strength of the first noise reduction processing is less than a processing strength of the second noise reduction processing.

In a possible implementation, the processor 1010 may be further configured to insert a noise compensation audio signal into at least one target frequency band after noise reduction is performed on the target audio signal in which fusion processing is performed on the corresponding transmission channel information. Each target frequency band is a frequency band in which an audio signal on which noise reduction is performed is located within the target frequency range. The noise compensation audio signal is used for compensating for an audio signal in a corresponding target frequency band.

In a possible implementation, the noise frequency band of the first audio signal and the noise frequency band of the second audio signal are obtained based on a target coherence coefficient between the first audio signal and the second audio signal.

In a possible implementation, the target coherence coefficient may include at least one of the following: a relative deviation coefficient; a relative strength sensitivity coefficient; a magnitude-squared coherence coefficient of an amplitude spectrum; or a magnitude-squared coherence coefficient of a phase spectrum.

In the electronic device provided in this embodiment of this application, before performing noise reduction processing on audio signals collected by different microphones, an electronic device may first perform fusion processing on transmission channel information based on frequency bands obtained through division and transmission channel information corresponding to each audio signal, and then perform noise reduction on an audio signal in which fusion processing is performed on corresponding transmission channel information. Therefore, the electronic device may process an audio signal with reference to transmission channel information corresponding to different audio signals in different frequency bands obtained through division rather than a feature of a single audio signal or all frequencies of a plurality of audio signals, so that robustness of processing the audio signal by the electronic device can be improved.

For beneficial effects of each implementation in this embodiment, refer to the beneficial effects of the corresponding implementation in the foregoing method embodiments. To avoid repetition, details are not described herein again.

It should be understood that in this embodiment of this application, the input unit 1004 may include a graphics processing unit (GPU) 10041 and a microphone 10042. The graphics processing unit 10041 performs processing on image data of a static picture or a video that is obtained by an image acquisition device (for example, a camera) in a video acquisition mode or an image acquisition mode. The display unit 1006 may include a display panel 10061, for example, the display panel 10061 configured in a form such as a liquid crystal display or an organic light-emitting diode. The user input unit 1007 includes at least one of a touch panel 10071 or another input device 10072. The touch panel 10071 is also referred to as a touchscreen. The touch panel 10071 may include two parts: a touch detection apparatus and a touch controller. The another input device 10072 may include, but not limited to, a physical keyboard, a functional key (such as a volume control key or a switch key), a track ball, a mouse, and a joystick, which are not described herein in detail.

The memory 1009 may be configured to store a software program and various data. The memory 1009 may mainly include a first storage area storing the program or the instructions and a second storage area storing data. The first storage area may store an operating system, an application program or instructions required by at least one function (for example, a sound playback function and an image display function), and the like. In addition, the memory 1009 may include a volatile memory or a non-volatile memory, or may include a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), or a direct rambus random access memory (DR RAM). The memory 1009 in this embodiment of this application includes but not limited to these memories and any other suitable types of memories.

The processor 1010 may include one or more processing units. Optionally, the processor 1010 integrates an application processor and a modem processor. The application processor mainly processes operations related to an operating system, a user interface, an application program, and the like. The modem processor mainly processes a wireless communication signal, for example, a baseband processor. It may be understood that the foregoing modem processor may not be integrated into the processor 1010.

An embodiment of this application further provides a non-transitory readable storage medium. The non-transitory readable storage medium stores a program or instructions. When the program or the instructions are executed by a processor, the processes of the foregoing embodiments of the audio signal processing method are implemented, and the same technical effect can be achieved. To avoid repetition, details are not repeated herein.

The processor is the processor in the electronic device in the foregoing embodiments. The non-transitory readable storage medium includes a non-transitory computer-readable storage medium such as a computer read-only memory ROM, a random access memory RAM, a magnetic disk, or an optical disc.

An embodiment of this application further provides a chip. The chip includes a processor and a communication interface, where the communication interface is coupled to the processor, and the processor is configured to run a program or instructions, to implement the processes of the foregoing embodiments of the audio signal processing method, and the same technical effect can be achieved. To avoid repetition, details are not repeated herein.

It should be understood that, the chip mentioned in this embodiment of this application may also be referred to as a system-level chip, a system chip, a chip system, a system on chip, or the like.

An embodiment of this application provides a computer program product. The program product is stored in a non-transitory storage medium. The program product is executed by at least one processor to implement the processes of the foregoing embodiments of the audio signal processing method, and the same technical effect can be achieved. To avoid repetition, details are not repeated herein.

It should be noted that, the terms “include”, “including”, or any other variation thereof in this specification is intended to cover a non-exclusive inclusion, which specifies the presence of stated processes, methods, objects, or apparatuses, but do not preclude the presence or addition of one or more other processes, methods, objects, or apparatuses. Without more limitations, elements defined by the sentence “including one” does not exclude that there are still other same elements in the processes, methods, objects, or apparatuses. In addition, it should be noted that, the scope of the methods and apparatuses in the implementations of this application is not limited to performing the functions in the order shown or discussed, but may further include performing the functions in a substantially simultaneous manner or in a reverse order depending on the functions involved. For example, the described methods may be performed in an order different from that described, and various steps may be added, omitted, or combined. In addition, features described with reference to some examples may be combined in other examples.

Through the descriptions of the foregoing implementations, a person skilled in the art may clearly understand that the methods in the foregoing embodiments may be implemented by means of software and a necessary general hardware platform, and certainly, may also be implemented by hardware. Based on such an understanding, the technical solutions of this application essentially or the part contributing to the related art may be implemented in the form of a computer software product. The computer software product is stored in a storage medium (such as a ROM/RAM, a magnetic disk, or an optical disc), and includes several instructions for instructing a terminal (which may be a mobile phone, a computer, a server, a network device, or the like) to perform the method described in the embodiments of this application.

The embodiments of this application are described above with reference to the accompanying drawings. However, this application is not limited to the foregoing implementations. The foregoing implementations are illustrative instead of limitative. Enlightened by this application, a person of ordinary skill in the art can make many forms without departing from the idea of this application and the scope of protection of the claims. All of the forms fall within the protection of this application.

What is claimed is:

1. An audio signal processing method, comprising:
dividing a target frequency range into a first frequency band and a second frequency band based on a noise frequency band of a first audio signal and a noise frequency band of a second audio signal, wherein the first audio signal is an audio signal obtained by collecting a target audio source by a first microphone, and the second audio signal is an audio signal obtained by collecting the target audio source by a second microphone;
performing first fusion processing on transmission channel information corresponding to the first audio signal and transmission channel information corresponding to the second audio signal in the first frequency band;
performing second fusion processing on the transmission channel information corresponding to the first audio signal and the transmission channel information corresponding to the second audio signal in the second frequency band; and
performing noise reduction on a target audio signal in which fusion processing is performed on corresponding transmission channel information, wherein the target audio signal comprises at least one of the first audio signal or the second audio signal.

2. The method according to claim 1, wherein the first frequency band is an intersection of the noise frequency band of the first audio signal and the noise frequency band of the second audio signal.

3. The method according to claim 1, wherein the second frequency band is a difference set between the noise frequency band of the first audio signal and the noise frequency band of the second audio signal.

4. The method according to claim 1, wherein the performing first fusion processing on transmission channel information corresponding to the first audio signal and transmission channel information corresponding to the second audio signal in the first frequency band comprises:
when a noise strength of a first sub-audio signal is less than a noise strength of a second sub-audio signal, combining transmission channel information corresponding to the first sub-audio signal and transmission channel information corresponding to the second sub-audio signal by using a first weight; or
when a noise strength of a first sub-audio signal is greater than a noise strength of a second sub-audio signal, combining transmission channel information corresponding to the second sub-audio signal and transmission channel information corresponding to the first sub-audio signal by using a second weight,
wherein the first sub-audio signal is an audio signal of the first audio signal in the first frequency band, and the second sub-audio signal is an audio signal of the second audio signal in the first frequency band.

5. The method according to claim 1, wherein the performing second fusion processing on the transmission channel information corresponding to the first audio signal and the transmission channel information corresponding to the second audio signal in the second frequency band comprises:
when a third sub-audio signal is a noise-free audio signal, combining transmission channel information corresponding to the third sub-audio signal and transmission channel information corresponding to a fourth sub-audio signal by using a third weight; or
when a fourth sub-audio signal is a noise-free audio signal, combining transmission channel information corresponding to the fourth sub-audio signal and transmission channel information corresponding to a third sub-audio signal by using a fourth weight,
wherein the third sub-audio signal is an audio signal of the first audio signal in the second frequency band; and the fourth sub-audio signal is an audio signal of the second audio signal in the second frequency band.

6. The method according to claim 1, wherein a processing strength of the first fusion processing is less than a processing strength of the second fusion processing.

7. The method according to claim 1, wherein the performing noise reduction on a target audio signal in which fusion processing is performed on corresponding transmission channel information comprises:
when a signal to wind noise ratio of the target audio signal is less than or equal to a preset threshold, performing noise reduction on the target audio signal by using a target noise reduction method,
wherein the target noise reduction method is a noise reduction method of performing first noise reduction processing on the target audio signal in a third frequency band and performing second noise reduction processing on the target audio signal in a fourth frequency band; and a frequency of the third frequency band is less than or equal to a first frequency threshold, a frequency of the fourth frequency band is greater than or equal to a second frequency threshold, and a processing strength of the first noise reduction processing is less than a processing strength of the second noise reduction processing.

8. The method according to claim 1, wherein after the performing noise reduction on a target audio signal in which fusion processing is performed on corresponding transmission channel information, the method further comprises:
inserting a noise compensation audio signal into at least one target frequency band,
wherein each target frequency band is a frequency band in which an audio signal on which noise reduction is performed is located within the target frequency range; and the noise compensation audio signal is used for compensating for an audio signal in a corresponding target frequency band.

9. The method according to claim 1, wherein the noise frequency band of the first audio signal and the noise frequency band of the second audio signal are obtained based on a target coherence coefficient between the first audio signal and the second audio signal.

10. The method according to claim 9, wherein the target coherence coefficient comprises at least one of the following:
a magnitude-squared coherence coefficient;
a relative deviation coefficient;
a relative strength sensitivity coefficient;
a magnitude-squared coherence coefficient of an amplitude spectrum; or
a magnitude-squared coherence coefficient of a phase spectrum.

11. An electronic device, comprising a processor and a memory, wherein the memory stores a program or instructions executable on the processor, and the program or the instructions, when executed by the processor, cause the electronic device to perform:
dividing a target frequency range into a first frequency band and a second frequency band based on a noise frequency band of a first audio signal and a noise frequency band of a second audio signal, wherein the first audio signal is an audio signal obtained by collecting a target audio source by a first microphone, and the second audio signal is an audio signal obtained by collecting the target audio source by a second microphone;
performing first fusion processing on transmission channel information corresponding to the first audio signal and transmission channel information corresponding to the second audio signal in the first frequency band;
performing second fusion processing on the transmission channel information corresponding to the first audio signal and the transmission channel information corresponding to the second audio signal in the second frequency band; and
performing noise reduction on a target audio signal in which fusion processing is performed on corresponding transmission channel information, wherein the target audio signal comprises at least one of the first audio signal or the second audio signal.

12. The electronic device according to claim 11, wherein the first frequency band is an intersection of the noise frequency band of the first audio signal and the noise frequency band of the second audio signal;
or,
the second frequency band is a difference set between the noise frequency band of the first audio signal and the noise frequency band of the second audio signal.

13. The electronic device according to claim 11, wherein the program or the instructions, when executed by the processor, cause the electronic device to perform:
when a noise strength of a first sub-audio signal is less than a noise strength of a second sub-audio signal, combining transmission channel information corresponding to the first sub-audio signal and transmission channel information corresponding to the second sub-audio signal by using a first weight; or
when a noise strength of a first sub-audio signal is greater than a noise strength of a second sub-audio signal, combining transmission channel information corresponding to the second sub-audio signal and transmission channel information corresponding to the first sub-audio signal by using a second weight,
wherein the first sub-audio signal is an audio signal of the first audio signal in the first frequency band, and the second sub-audio signal is an audio signal of the second audio signal in the first frequency band.

14. The electronic device according to claim 11, wherein the program or the instructions, when executed by the processor, cause the electronic device to perform:
when a third sub-audio signal is a noise-free audio signal, combining transmission channel information corresponding to the third sub-audio signal and transmission channel information corresponding to a fourth sub-audio signal by using a third weight; or
when a fourth sub-audio signal is a noise-free audio signal, combining transmission channel information corresponding to the fourth sub-audio signal and transmission channel information corresponding to a third sub-audio signal by using a fourth weight,
wherein the third sub-audio signal is an audio signal of the first audio signal in the second frequency band; and the fourth sub-audio signal is an audio signal of the second audio signal in the second frequency band.

15. The electronic device according to claim 11, wherein a processing strength of the first fusion processing is less than a processing strength of the second fusion processing.

16. The electronic device according to claim 11, wherein the program or the instructions, when executed by the processor, cause the electronic device to perform:
when a signal to wind noise ratio of the target audio signal is less than or equal to a preset threshold, performing noise reduction on the target audio signal by using a target noise reduction method,
wherein the target noise reduction method is a noise reduction method of performing first noise reduction processing on the target audio signal in a third frequency band and performing second noise reduction processing on the target audio signal in a fourth frequency band; and a frequency of the third frequency band is less than or equal to a first frequency threshold, a frequency of the fourth frequency band is greater than or equal to a second frequency threshold, and a processing strength of the first noise reduction processing is less than a processing strength of the second noise reduction processing.

17. The electronic device according to claim 11, wherein the program or the instructions, when executed by the processor, cause the electronic device to further perform:
inserting a noise compensation audio signal into at least one target frequency band,
wherein each target frequency band is a frequency band in which an audio signal on which noise reduction is performed is located within the target frequency range; and the noise compensation audio signal is used for compensating for an audio signal in a corresponding target frequency band.

18. The electronic device according to claim 11, wherein the noise frequency band of the first audio signal and the noise frequency band of the second audio signal are obtained based on a target coherence coefficient between the first audio signal and the second audio signal.

19. A non-transitory readable storage medium, wherein the non-transitory readable storage medium stores a program or instructions, and the program or the instructions, when executed by a processor of an electronic device, cause the electronic device to perform:
dividing a target frequency range into a first frequency band and a second frequency band based on a noise frequency band of a first audio signal and a noise frequency band of a second audio signal, wherein the first audio signal is an audio signal obtained by collecting a target audio source by a first microphone, and the second audio signal is an audio signal obtained by collecting the target audio source by a second microphone;
performing first fusion processing on transmission channel information corresponding to the first audio signal and transmission channel information corresponding to the second audio signal in the first frequency band;
performing second fusion processing on the transmission channel information corresponding to the first audio signal and the transmission channel information corresponding to the second audio signal in the second frequency band; and
performing noise reduction on a target audio signal in which fusion processing is performed on corresponding transmission channel information, wherein the target audio signal comprises at least one of the first audio signal or the second audio signal.

20. The non-transitory readable storage medium according to claim 19, wherein the first frequency band is an intersection of the noise frequency band of the first audio signal and the noise frequency band of the second audio signal;
or,
the second frequency band is a difference set between the noise frequency band of the first audio signal and the noise frequency band of the second audio signal.
